(19) United States
(12) Patent Application Publication
(10) Pub. No.: US 2015/0129040 A1
(43) Pub. Date: May 14, 2015

(54) APPARATUS FOR MIXING A FIRST STREAM AND A SECOND STREAM OF A FLOW MEDIUM

(71) Applicants: Rainer Hartig, Buxtehude (DE); Dierk Schröder, Selent (DE)

(72) Inventors: Rainer Hartig, Buxtehude (DE); Dierk Schröder, Selent (DE)

(73) Assignee: SIEMENS AKTIENGESELLSCHAFT, Munich (DE)

(21) Appl. No.: 14/119,297

(22) PCT Filed: May 18, 2012
(86) PCT No.: PCT/EP2012/059297

§ 371 Date: Nov. 21, 2013

(30) Foreign Application Priority Data
May 25, 2011 (DE) 102011076456.9

(51) Int. Cl. B01F 5/02; F28F 13/06

(52) U.S. Cl. CPC B01F 5/0293; F28F 13/06; B01F 2005/0045
USPC 137/1; 137/833

(57) ABSTRACT

An apparatus is disclosed for mixing a first stream of a flow medium and a second stream of the flow medium, a temperature of the first and second streams being different. In an embodiment, the apparatus includes at least one mixing apparatus configured as a blade-free fan, including at least one opening and a Coanda surface arranged in the region of the at least one opening. During operation, the first stream emerges from the at least one opening and can be steered by the Coanda surface, wherein the second stream flows in the region of the at least one opening, and wherein the first stream, following the emergence thereof from the at least one opening, is mixable with the second stream. The apparatus also includes a first infeed for the first stream and a second infeed for the second stream, first and second infeeds being configured as a double-walled tube.

### PRIORITY STATEMENT

This application is the national phase under 35 U.S.C. §371 of PCT International Application No. PCT/EP2012/059297 which has an International filing date of May 18, 2012, which designated the United States of America and which claims priority to German patent application number DE 10 2011 076 456.9 filed May 25, 2011, the entire contents of each of which are hereby incorporated herein by reference.

### FIELD

At least one embodiment of the invention generally relates to an apparatus for mixing a first stream and a second stream of a flow medium, wherein a temperature of the first stream is different from a temperature of the second stream, and having at least one mixing apparatus.

### BACKGROUND

Different types of apparatus for mixing two medium streams are known. In order to set a mixing ratio, for example, an adjustable flap is used. Depending on the positioning, for example, a greater proportion of the cooler medium stream can be fed to a combined medium stream, leading to cooling.

Air-conditioning systems known from the prior art for premises having a plurality of rooms to be conditioned feed cooled air to each room. The temperature of the air is typically below the requirements of the room occupants. Therefore the temperature must be readjusted for each room individually by way of reheating units.

US 2009/060710 A1 discloses a blade-free fan by which first and second air streams can be mixed. The blade-free fan has an opening and a Coanda surface in the region of the opening, wherein the first air stream emerges from the opening and is steered by the Coanda surface. The second air stream flows in the region of the opening, wherein the first air stream mixes, following the emergence thereof from the opening, with the second air stream.

### SUMMARY

At least one embodiment of the present invention provides an apparatus and/or a method which advantageously adjust(s) a mixing ratio of differently treated streams of a flow medium.

At least one embodiment of the invention is directed to an apparatus and at least one embodiment of the invention is directed to a method.

At least one embodiment of the invention provides an air-conditioning system and/or a method for operating an air-conditioning system wherein the reheating of a room can be dispensed with.

At least one embodiment of the invention is directed to an air-conditioning system and at least one embodiment of the invention is directed to a method.

It is proposed that the mixing apparatus of at least one embodiment is configured as a blade-free fan which includes at least one opening and a Coanda surface arranged in the region of the at least one opening, wherein the first stream of medium emerges from the at least one opening and can be steered by the Coanda surface, wherein the second stream flows in the region of the at least one opening, and wherein the first stream, following the emergence thereof from the at least one opening, can be mixed with the second stream.

The apparatus has a first infeed for the first stream and a second infeed for the second stream. The first infeed and the second infeed are configured as a double-walled tube.

By way of at least one embodiment of the inventive configuration, energy-efficient and even air-conditioning, for example, of a room can be achieved with a simple design. Furthermore, structures of large volume, for example, reheating units outside the room, such as are commonly known from the prior art, can be dispensed with. A space-saving arrangement can therefore be provided. The configuration according to at least one embodiment of the invention also offers a greater power density as compared with prior art arrangements. An apparatus of this type also produces little noise. By way of the configuration of the infeeds as a double-walled tube, the infeeds can be realized in a space-saving and component-saving manner.

An apparatus according to at least one embodiment of the invention represents, in particular, part of an air-conditioning system, for example, an air-conditioning plant. An air-conditioning system of this type can advantageously be used in arrangements wherein a plurality of independent compartments or rooms are to be supplied from a central air-conditioning unit. This is the case, for example, in office buildings, hotels, ships or similar facilities. In these cases, a desired parameter, for example, a temperature, an air humidity or another parameter regarded by a person skilled in the art as being useful can be separately adjusted for each individual compartment or for each individual room by way of a mixing apparatus arranged in the region of each compartment or room. This saves space and components. Furthermore, generally applicable settings and manipulated variables can be adjusted to suit the components of the central air-conditioning unit with little effort.

At least one embodiment of the invention also relates to a method for mixing a first stream of a flow medium and a second stream of the flow medium, wherein a temperature of the first stream is different from a temperature of the second stream, making use of the apparatus according to at least one embodiment of the invention.

It is proposed that the first stream of medium is blown out of at least one opening of a mixing apparatus and is steered by a Coanda surface arranged in the region of the at least one opening, wherein the first stream, following the emergence thereof from the at least one opening, is mixed with the second stream. By way of the inventive configuration, rapid and even air-conditioning of a room can be achieved. A greater power density can also be achieved as compared with prior art methods.

Furthermore, at least one embodiment of the invention relates to an air-conditioning system as described above and a method for operating the system.

It is proposed that a parameter is selected at an adjusting unit and, depending on said parameter, a state parameter of a first stream of medium is influenced and/or an operational parameter of a mixing apparatus is influenced, so that following the emergence of the first stream of medium from at least one opening of a mixing apparatus, steering and/or control and/or regulation of the first stream of medium by means of the mixing apparatus and mixing of the first stream with a second stream, the parameter has been adjusted. By means of the inventive configuration, rapidly adaptable and even air-conditioning of a room can be achieved.

In this context, an adjusting unit is, in particular, an operating panel such as a keypad or a touchpad by which a desired parameter can be set and/or selected, in particular, by an operator.

A parameter in this context should be understood to be, for example, a temperature, a humidity and/or any other parameter deemed useful by a person skilled in the art and which should prevail in the region and/or room to be air-conditioned. Said parameter is, in particular, a temperature evoking a feeling of wellbeing. A state parameter of the first flow medium can be influenced, for example, by a variable adjustment of a diameter of the first infeed. The operational parameter of the mixing apparatus can be influenced, for example, by an axial displacement.

### BRIEF DESCRIPTION OF THE DRAWINGS

The invention will now be described in greater detail by reference to example embodiments which are illustrated in the drawings.

In the drawings:

FIG. 1 is an air-conditioning system according to an embodiment of the invention with a plurality of inventive apparatuses in an overview,

FIG. 2 is an an embodiment of an inventive apparatus of FIG. 1 with a mixing apparatus in a sectional view,

FIG. 3 is the mixing apparatus of FIG. 2 in a front view,

FIG. 4 is a perspective enlarged view of part of the mixing apparatus of FIG. 2,

FIG. 5 is a block circuit diagram to illustrate the method for operating the air-conditioning system of FIG. 1, and

FIG. 6 is an alternative apparatus having an infeed with two tubes configured separately from one another, in a sectional view.

### DETAILED DESCRIPTION OF THE EXAMPLE EMBODIMENTS

An apparatus according to at least one embodiment of the invention represents, in particular, part of an air-conditioning system, for example, an air-conditioning plant. An air-conditioning system of this type can advantageously be used in arrangements wherein a plurality of independent compartments or rooms are to be supplied from a central air-conditioning unit. This is the case, for example, in office buildings, hotels, ships or similar facilities. In these cases, a desired parameter, for example, a temperature, an air humidity or another parameter regarded by a person skilled in the art as being useful can be separately adjusted for each individual compartment or for each individual room by way of a mixing apparatus arranged in the region of each compartment or room. This saves space and components. Furthermore, generally applicable settings and manipulated variables can be adjusted to suit the components of the central air-conditioning unit with little effort.

In this context, a mixing apparatus is an apparatus which, by influencing at least one state parameter of a stream of medium, for example, a temperature, a speed, a pressure, a humidity and/or another state parameter deemed by a person skilled in the art to be conceivable and meaningful, mixes said stream of medium with a further stream of medium. A mixing apparatus is, in particular, a local mixing apparatus. A difference in the temperatures of the first and second stream of medium is to be selected depending on the ratio of the size of the two streams of medium. Advantageously for rooms occupied by humans, the resultant mixing temperature is to be selected so that the requirements of a sense of wellbeing and of medical considerations are taken into account. For other rooms, the respective mixing temperature is to be selected depending on use.

An infeed should be understood to be an apparatus which pre-determines a direction and/or a route for the stream of medium, in particular from the fluid flow machine to the mixing apparatus. Using the infeeds, the flow medium can be transported in a targeted manner.

A fan should be understood in this context to be an apparatus which accelerates and possibly compresses the flow medium, for example, a liquid, a gas and in particular air. The flow medium of the first and the second stream can be of the same flow medium or said streams can be of different flow media.

The fan is preferably configured blade-free, meaning that a stream of the flow medium which is output or expelled is produced without the aid of wings, rotor blades or a rotating component. The part of the fan from which the stream of flow medium emerges, such as a distribution ring or an opening thereon, thus has no wings, rotor blades or rotating components. With this blade-free embodiment, fluttering and/or inconstant emergence of the stream of flow medium during flow thereof out of the blade-free fan can be prevented. Therefore, a smooth stream of the flow medium or air stream emerges from the fan. In addition, due to the lack of a large rotating fan rotor, less soiling occurs in the vicinity of the blade-free fan than in an apparatus with a fan according to the prior art. Furthermore, the risk of an accident, for example, through contact with rotating components, is entirely prevented. A reduction in noise also results, since no large volume of the flow medium is moved.

Regardless of the description above and without influencing the definition of the fan as blade-free, the apparatus can comprise a primary source for the first stream of flow medium. This primary source can be any device deemed suitable by a person skilled in the art, for example, a pump, a generator, a motor, an impeller or compressor. Furthermore, this definition of the blade-free fan does not extend to components of the apparatus which perform secondary functions, for example, distance adjustment, angle adjustment or a change in a flow intensity.

An opening should be understood herein to be a hole or a slit. In principle, a plurality of holes or slits can be provided. The Coanda surface can be arranged at any conceivable site in the region of the opening, but preferably directly at the opening.

In this regard, a Coanda surface should be understood as a surface with which a flow medium emerging from an opening and following a surface shows the Coanda effect. The stream of flow medium has the tendency to “run along” a convex surface rather than separating therefrom and running in the original movement direction. The Coanda effect is a well known and established entrainment effect wherein a primary stream of medium is steered by a Coanda surface. In this regard, the expression “steerable” should also be understood to mean controllable and/or regulable. A description of the features of a Coanda surface and of the effects of the stream of medium at the Coanda surface can be found in scientific publications, for example, in Reba, Scientific American, issue 214, June 1966, pages 84 to 92.

The wording “that the second stream flows in the region of the at least one opening”, should be understood to mean that the flow medium of the second stream of medium is situated in the region or around the at least one opening and, in particular, that the second stream of medium moves past the at least one opening. The emergence of the first stream of medium from the at least one opening preferably takes place in a directed manner and in the direction toward a compartment or room to be air-conditioned and is blown out, for example, for cooling thereof. A flow direction is therefore in the direction of the room. The first stream of medium preferably enters the blade-free fan via at least one cut-out which is distinct from the at least one opening. Furthermore, in this regard, “mixable” should be understood to mean that the first and second streams of medium can be unified to a single combined medium stream.

It is also proposed that in an intended operating mode of the mixing apparatus, the temperature of the second stream of medium flowing in the region of the at least one opening is higher than the temperature of the first stream of medium emerging from the at least one opening. At least one embodiment of an inventive operating mode should be understood to be a normal operation and/or a conditioning operation of the apparatus. A difference in the temperatures of the first and second streams of medium is to be selected depending on the ratio of the size of the two medium streams.

Advantageously for rooms occupied by humans, the resultant mixing temperature is to be selected so that the requirements of a feeling of wellbeing and of medical considerations are taken into account. For other rooms, the respective mixing temperature is to be selected depending on use. By means of this temperature difference, a change in an existing temperature in the room to be air-conditioned can be achieved using a simple design.

It is provided in a further embodiment of the invention that, in an operating mode of the mixing apparatus according to the invention, a speed of the second stream of medium flowing in the region of the at least one opening is lower than a speed of the first stream of medium emerging from the at least one opening. The speed of the first stream of medium is, for example, in the range of 2 meters per second to 10 meters per second (m/s) and the speed of the second stream of medium is in the range of 10% to 90% of the speed of the first stream of medium. As a result of the different speeds of the two streams of medium, said streams can be effectively mixed by means of an entrainment effect of the second stream by the first stream.

It is also advantageous if, in at least one embodiment of an inventive mode of operation of the mixing apparatus, a pressure of the second stream of medium flowing in the region of the at least one opening is lower than a pressure of the first stream of medium emerging from the at least one opening. A pressure of the first stream of medium is, for example, in the range of 0.5 bar to 5 bar and the pressure of the second stream of medium is in the range of 10% to 90% of the pressure of the first stream. By way of the pressure difference, the entrainment and thus the mixing can be achieved with a simple design.

It is also proposed that the blade-free fan has at least one distribution channel for at least the first stream of flow medium. In this regard, a distribution channel should be understood as a structure which encloses the stream of flow medium and/or defines a flow direction of the stream of medium. Advantageously, the distribution channel supplies the at least one opening with flow medium. The configuration of the distribution channel enables the flow medium to be conducted and guided to the opening with a simple design.

The distribution channel can have any form conceivable by a person skilled in the art, such as racetrack-shaped, rod-shaped, polygonal, rectangular, oval, semicircular and, in particular, circular. Advantageously, the distribution channel extends over at least a partial region of the blade-free fan, so that the first stream of flow medium can be sufficiently well distributed via the fan. The partial region can be an angular region, a sector of an annulus, half of an annulus or, preferably, an annulus. The at least one opening is preferably adapted to the configuration of the distribution channel and extends along the whole extent thereof. In particular, the opening is configured as a slit which is concentric with the distribution channel or the annular shape thereof.

It is further proposed that the blade-free fan is configured annular. By this, the blade-free fan can be realized with a low weight. Furthermore, the blade-free fan therefore has a central cut-out, so that the second stream of medium can be guided unhindered past the typically one opening in the distribution channel.

It is also advantageous if the distribution channel and the blade-free fan have the same shape, e.g. an annular shape, so that the distribution channel can be easily integrated into the blade-free fan by way of a simple design. The distribution channel therefore extends along an entire periphery of the blade-free fan. A wall of the distribution channel preferably provides a basic shape of the blade-free fan and/or the fan provides a wall of the distribution channel.

It is also possible to configure the fan with a multi-staged or multi-flow design. It is also fundamentally possible for different forms to be combined.

It is also advantageous if the at least one opening has an opening direction which is oriented essentially parallel to the flow direction. The opening direction therefore faces into the room to be air-conditioned. Use of the expression “essentially parallel” should be understood to mean that a deviation of the opening direction at an angle of up to 30° from the flow direction should be understood as a parallel arrangement. Preferably, however, the opening direction and the flow direction are parallel to one another. With the orientation according to at least one embodiment of the invention, it can be achieved that the first stream of flow medium is able to flow out of the opening without hindrance and without turbulence.

Advantageously, the at least one opening is configured to give the blade-free fan the effect of a nozzle. By this means, the first stream of flow medium can be accelerated by a simple design. As a result of the accelerated emergence of the first stream of flow medium from the at least one opening and the interaction with the Coanda surface, a second stream of flow medium flowing in the region of the opening can be entrained. Finally, a combined medium stream emerging from the mixing apparatus is intensified many times over as compared with the first stream of flow medium. This intensification has a factor of, for example, 15. The central cut-out of the blade-free fan has also proved to be advantageous because the second stream of flow medium can thus flow in unhindered and become entrained.

The Coanda surface can have any orientation deemed to be practicable by a person skilled in the art. In a further embodiment of the invention, it is provided, however, that the Coanda surface is arranged in the flow direction of the first stream of medium after the at least one opening. The opening represents an outlet site of the first stream of flow medium out of the distribution channel. The opening is also arranged at the distribution channel where, in a configuration of two adjacent walls of the distribution channel, one of said walls ends. In addition, an extension surface of the opening is oriented perpendicular to the flow or opening direction, wherein the extension surface is oriented perpendicular to the opposite wall, starting from the end of the shorter wall. By means of this arrangement, the first stream of flow medium can flow immediately over the Coanda surface after emerging from the opening.

It is also proposed that the Coanda surface extends symmetrically to an axis. In particular, the axis coincides with an axis through the center of a circle of the blade-free fan or the distribution channel. In addition, the axis extends coaxially with an axis of at least one infeed for a stream of medium, in particular the second stream of medium. With this arrangement, a stream of medium, in particular the second stream of the flow medium can flow evenly past the blade-free fan.

Suitably, the Coanda surface and the axis enclose an angle in the range of 7° to 20° and, in particular, 15°. These values have proved to be particularly effective for utilizing the Coanda effect. With these values, a sufficient first stream of flow medium over the Coanda surface can be achieved, which leads to effective entrainment of the second stream of flow medium and thus to a maximized combined medium stream.

Furthermore, it can be advantageous if the apparatus has a fluid flow machine which generates the first stream of medium and is adjustable by way of the at least one state parameter of the first stream of medium. The fluid flow machine is the primary source described above for generating the first stream of medium and is preferably configured as a turbine unit or a compressor. As described above, a state parameter should be understood to be, for example, a temperature, a speed, a pressure, a humidity and/or any other state parameter deemed by a person skilled in the art to be suitable. By way of the fluid flow machine, the first stream of medium can be generated by a simple design and the state parameters thereof can be adjusted in an uncomplicated manner.

The fluid flow machine can be arranged directly in the vicinity of the mixing apparatus, for example, in the same room as the blade-free fan. Preferably, however, the fluid flow machine is arranged outside the room in which the mixing apparatus is situated. In particular, the fluid flow machine is arranged in a region or room which is connected by at least two infeeds for at least two mixing apparatuses to the two rooms in which the mixing apparatuses are situated. By this means, a plurality of mixing apparatuses can be advantageously operated with the same fluid flow machine in a way that saves cost and components. Furthermore, the fluid flow machine can be placed at a distance from the mixing apparatus, so that a particularly low-noise mixing apparatus can be provided for air-conditioning the room.

Effective guidance of the flow medium can advantageously be achieved if the blade-free fan is arranged concentrically in relation to at least one infeed. Furthermore, entrainment of the second stream of medium which flows through the cut-out in the blade-free fan can take place particularly evenly if the blade-free fan and/or the distribution channel extends concentrically at least to the second infeed. In principle, however, a non-centered arrangement is also conceivable.

The first infeed and the second infeed can be positioned relative to one another in any arrangement deemed practicable by a person skilled in the art, such as perpendicular, parallel or inclined.

The first and second infeed are preferably arranged concentrically with one another. The first infeed is particularly preferably arranged in a peripheral direction around the second infeed. In principle, however, a non-centered arrangement is also conceivable.

It can be advantageous for an operational parameter of the mixing apparatus and/or of the blade-free fan to be adjustable. An operational parameter should be understood in this context to mean a form, size, position, orientation and/or any other operational parameter deemed by a person skilled in the art to be adjustable.

A further embodiment of the invention provides that the blade-free fan is arranged axially displaceable relative to an infeed which feeds the first stream of medium and/or the second stream of medium to the mixing apparatus. It would also be possible, in principle, to adjust an orientation of the blade-free fan relative to at least one of the infeeds by tilting or by adjusting an angle. The position change can be carried out, for example, by way of a positioning motor. Using the possibility of moving the blade-free fan, a state parameter of a stream of medium can be adjusted by a simple design. This results in an alternative and/or additional adjusting device for the fluid flow machine.

At least one embodiment of the invention also relates to a method for mixing a first stream of a flow medium and a second stream of the flow medium, wherein a temperature of the first stream is different from a temperature of the second stream, making use of the apparatus according to at least one embodiment of the invention.

It is proposed that the first stream of medium is blown out of at least one opening of a mixing apparatus and is steered by a Coanda surface arranged in the region of the at least one opening, wherein the first stream, following the emergence thereof from the at least one opening, is mixed with the second stream. By way of the inventive configuration, rapid and even air-conditioning of a room can be achieved. A greater power density can also be achieved as compared with prior art methods.

Furthermore, at least one embodiment of the invention relates to an air-conditioning system as described above and a method for operating the system.

It is proposed that a parameter is selected at an adjusting unit and, depending on said parameter, a state parameter of a first stream of medium is influenced and/or an operational parameter of a mixing apparatus is influenced, so that following the emergence of the first stream of medium from at least one opening of a mixing apparatus, steering and/or control and/or regulation of the first stream of medium by means of the mixing apparatus and mixing of the first stream with a second stream, the parameter has been adjusted. By means of the inventive configuration, rapidly adaptable and even air-conditioning of a room can be achieved.

In this context, an adjusting unit is, in particular, an operating panel such as a keypad or a touchpad by which a desired parameter can be set and/or selected, in particular, by an operator.

A parameter in this context should be understood to be, for example, a temperature, a humidity and/or any other parameter deemed useful by a person skilled in the art and which should prevail in the region and/or room to be air-conditioned. Said parameter is, in particular, a temperature evoking a feeling of wellbeing. A state parameter of the first flow medium can be influenced, for example, by a variable adjustment of a diameter of the first infeed. The operational parameter of the mixing apparatus can be influenced, for example, by an axial displacement.

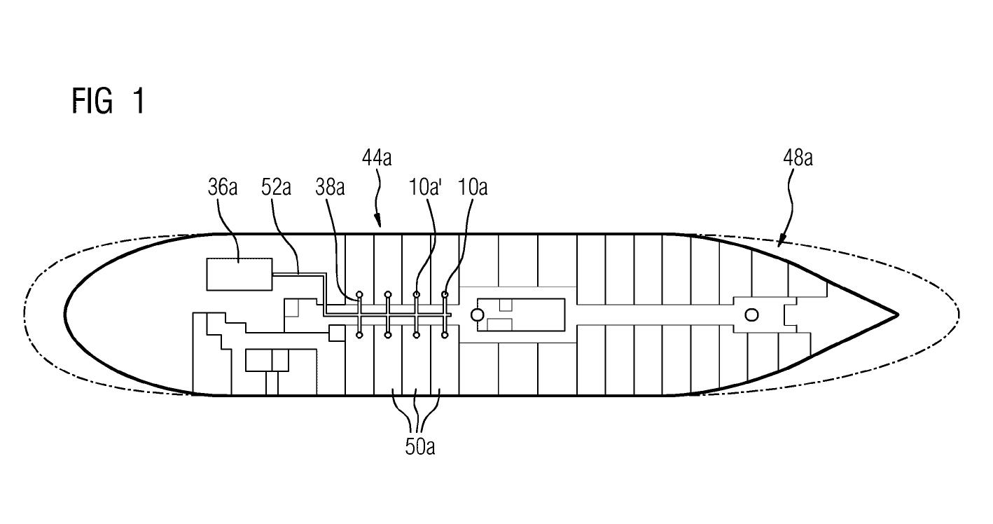

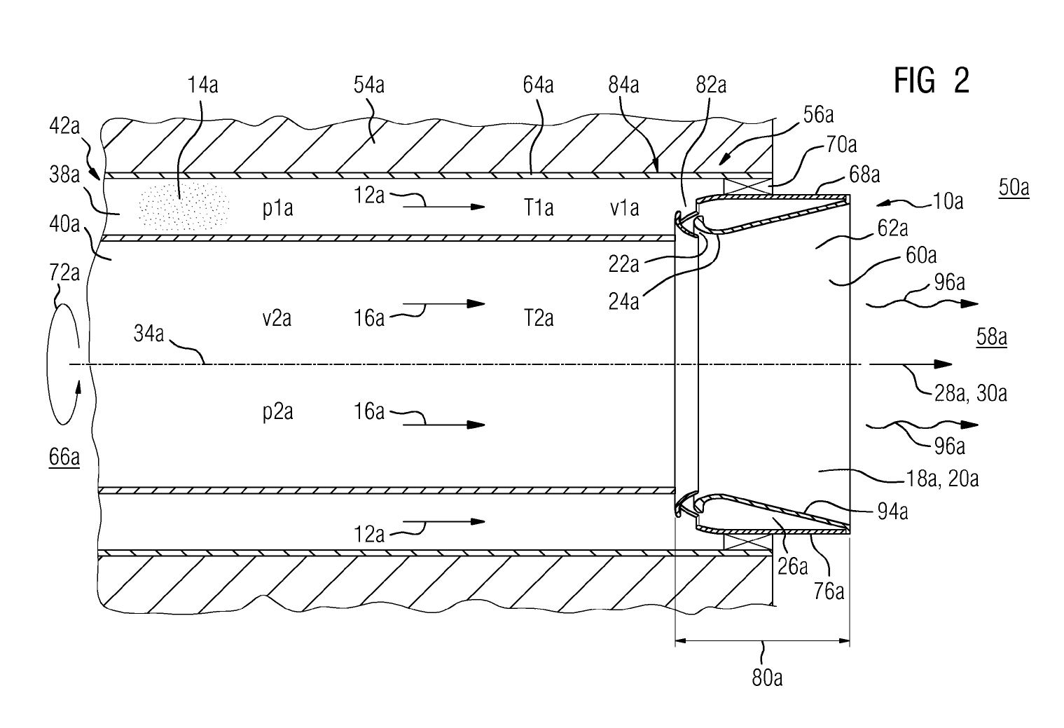

FIG. 1 shows an air-conditioning system 44a in the form of an air-conditioning plant for a ship 48a, of which by way of example, a deck with cabins 50a is represented. The air-conditioning system 44a comprises an apparatus 10a, 10a′ per cabin 50a for mixing a first stream 12a of a flow medium 14a and a second stream 16a of the flow medium 14a, wherein a temperature T1a of the first stream 12a is different from a temperature T2a of the second stream 16a (see FIG. 2). The flow medium 14a in this case is air. The air-conditioning system 44a or the apparatuses 10a, 10a′ also comprise a fluid flow machine 36a in the form of a compressor, which supplies the cabins 50a centrally with the first stream 12a of the flow medium 14a (shown, by way of example, for some cabins 50a). A central conduit 52a conducts the first stream 12a from a room in which the fluid flow machine 36a is arranged, to the cabins 50a. At the cabins 50a, the central conduit 52a forks so that, for each cabin 50a, a first infeed 38a feeds the first stream 12a to the cabin 50a.

FIG. 2 shows a section through a region of a cabin wall 54a in which part of the apparatus 10a is arranged. The apparatus 10a has a mixing apparatus 18a which is arranged at one end 56a of the first infeed 38a, the end 56a facing toward an interior space 58a of the cabin 50a. The mixing apparatus 18a is therefore arranged at a side of the cabin wall 54a which faces toward the interior space 58.

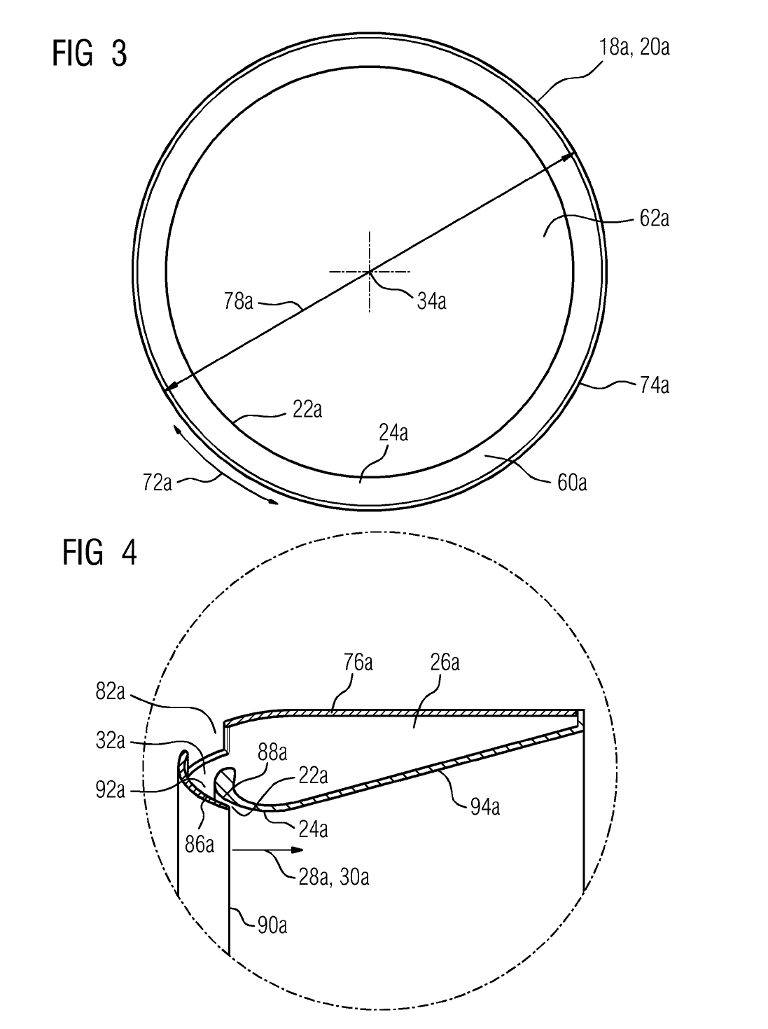

The mixing apparatus 18a is configured as a blade-free fan 20a. Furthermore, the blade-free fan 20a is configured annular such that the annulus 60a extends centrally about an axis 34a and with the form and extent thereof defines a cut-out 62a (see FIG. 3). A wall 64a of the first infeed 38a also extends centrally about the axis 34a. The first infeed 38a is configured, together with a second infeed 40a for the second stream of medium 16a, as a double-walled tube 42a. The second infeed 40a connects an outer region 66a of the cabin 50a, for example, a gangway of the deck, to the interior space 58a of the cabin 50a. The second infeed 40a thus guides flow medium 14a from outside the cabin 50a to the mixing apparatus 18a. The second stream of medium 16a can therefore emerge through the cut-out 62a of the annulus 60a of the blade-free fan 20a.

The blade-free fan 20a is arranged axially displaceable relative to the first and second infeed 38a, 40a. By this, an operational parameter B1a of the mixing apparatus 18a, such as a relative position of the blade-free fan 20a, can be changed for example with an adjusting element or motor (not shown). In order to achieve this without the emergence of flow medium 14a at the mixing apparatus 18a, a seal 70a is provided between the wall 64a of the first infeed 38a and an outer surface 68a of the fan 22a.

In an operating mode of the mixing apparatus 18a according to an embodiment of the invention, that is, in the normal air-conditioning operation of the mixing apparatus 18a, the temperature T1a of the second stream of medium 16a is higher than the temperature T2a of the first stream of medium 12a. In the mode, for example, the temperature T1a is 10° C. and the temperature T2a is 22° C. Furthermore, a speed via of the second stream 16a is lower than a speed v2a of the first stream 12a. For example, the speed via is 2 m/s and the speed v2a is 1 m/s. Furthermore, a pressure p1a of the second stream 16a is lower than a pressure p2a of the first stream 12a. For example, the pressure p1a is 2 bar and the pressure p2a is 1 bar. In principle, the mixing apparatus 18a also operates with the first and second streams of medium 12a, 16a having equal speeds and equal pressures.

The blade-free fan 20a has a distribution channel 26a for the first stream 12a. The distribution channel 26a is also configured annular and thus extends in a peripheral direction 72a round a whole periphery 74a of the blade-free fan 20a. The fan 20a forms a wall 76a of the distribution channel 26a. In the example embodiment shown, the blade-free fan 20a and the annulus 60a have an external diameter 78a of 200 mm (see FIG. 3). A depth 80a of the fan 22a coaxially with the axis 34a is 30 mm and the distribution channel 26a is narrower along the extent of the wall 76a.

The first stream 12a of the flow medium 14a passes in a flow direction 30a through a cut-out 82a which is arranged at one side 84a of the fan 22a which faces into the distribution channel 26a in the direction of the first infeed 38a. The blade-free fan 20a or the distribution channel 26a thereof also has an opening 22a wherein the opening 22a is supplied with flow medium 14a by the distribution channel 26a. The opening 22a has an opening direction 28a which is oriented parallel to or coaxially with the axis 34a and the flow direction 30a of the first stream 12a. Furthermore, the opening 22a is formed by an annular slit which extends along the annulus 60a of the blade-free fan 20a.

As FIG. 4 shows, in the region of the opening 22a, the wall 76a of the blade-free fan 20a has an inner wall region 86a and an outer wall region 88a which, in a folded arrangement, are disposed opposing one another. An imaginary extent surface of the opening 22a extends, starting from one end 90a of the inner wall region 86a, perpendicular to the opposing outer wall region 88a and perpendicular to the flow direction 30a or the opening direction 28a. An extent of the opening 22a along the extent surface from the end 90a to the opposing external wall region 88a has a width in the region of 1 mm to 5 mm, preferably 1.3 mm. Arranged in the flow direction 30a in front of the opening 22a is a constriction region 92a which narrows conically toward the opening 22a, by means of which the opening 22a is configured to give the blade-free fan 20a the effect of a nozzle 32a.

A Coanda surface 24a is provided in the region of the opening 22a and in the flow direction 30a of the first stream 12a following the opening 22a. The Coanda surface 24a extends symmetrically to the axis 34a. The Coanda surface 24a and the axis 34a enclose an angle of 15°. Arranged following the Coanda surface 24a in the flow direction 30a is a guiding surface 94a which extends over approximately two-thirds of the depth 80a of the fan 20a. The guiding surface 94a and the general design of the blade-free fan 20a are conformed to the shape of an airfoil.

Following emergence from the opening 22a, the first stream 12a of the flow medium 14a is steered by the Coanda surface 24a and mixes with the second stream 16a of medium which flows in the region of the opening 22a through the cut-out 62a of the annulus 60a. The guiding surface 94a promotes the directed outflow of the first stream 12a of medium. Thus, the mixed streams 12a, 16a of medium emerge in the direction of the interior space 58a of the cabin 50a (see FIG. 2).

The functioning of the mixing apparatus 18a will now be described in greater detail by reference to FIGS. 2 to 4. The fluid flow machine 36a generates the first stream 12a of medium, which is fed, by way of the first infeed 38a of the mixing apparatus 18a and the distribution channel 26a of the fan 20a through the recess 82a. Before emerging from the opening 22a, the first stream 12a of flow medium 14a is constricted firstly in the constriction region 92a and then at the opening 22a.

The emergence of the first stream 12a of medium from the opening 22a generates a negative pressure at the cut-out 82a and leads to additional suction of the flow medium 14a through the cut-out 82a into the mixing apparatus 18a. The flow of the first stream 12a of medium over the Coanda surface 24a and the guiding surface 94a intensifies the first stream 12a of flow medium 14a by means of the Coanda effect. The second stream 16a of flow medium 14a is also influenced.

This stream is located or flows in the region of the opening 22a. Due to the immediate proximity of the opening 22a, the second, for example, warm stream 16a of medium is entrained by the first, for example, cold stream 12a of medium, so that re-heating of the cabin 50a by, for example, a reheating unit can be dispensed with. As a result of the entrainment, the second stream 16a of medium flows through the cut-out 62a so that a part thereof can flow over the guiding surface 94a and becomes united with the first stream 12a of medium into a combined stream 96a of the flow medium 14a. The combined stream 96a flows in the flow direction 30a into the interior space 58a of the cabin 50a in order to air-condition, particularly to cool the cabin 50a.

Higher speeds can be achieved by reducing the angle that is enclosed between the Coanda surface and the axis. A smaller angle has the result that the combined stream flows out in a more focused and directed manner. A combined stream of this type is ejected at a greater speed and a reduced flow volume rate. Conversely, a higher volume flow rate can be achieved by increasing the angle enclosed between the Coanda surface and the axis. In this way, the speed of the combined stream is reduced, although the volume flow rate is increased.

The dimensions and power of the apparatus 10a are dependent, for example, on the type of fluid flow machine used and the volume of the room that is to be air-conditioned.

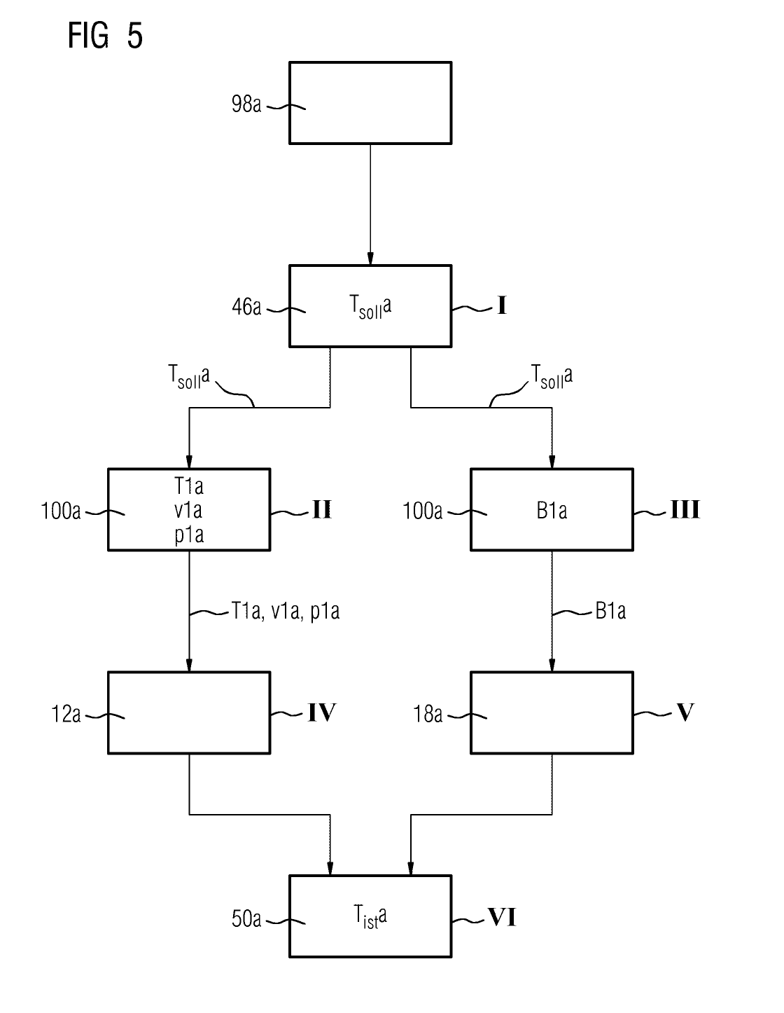

The operation of the air-conditioning system 44a will now be described by reference to FIG. 5. An operator 98a selects a parameter Tsolla, at I, at an adjusting unit 46a which consists, for example, of a touch pad. The parameter Tsolla represents, for example, a temperature evoking a feeling of wellbeing for the operator 98a in the cabin 50a. This parameter Tsolla is now passed, at II/III, to an adjusting element 100a or a plurality of adjusting elements 100a which influence, at IV, the state parameters Tia, pia, via of the first stream 12a of medium depending on the selected parameter Tsolla. For each temperature Tsolla, value tables of the state parameters Tia, via, pia are stored. Alternatively or additionally, at V, an adjusting element 100a can also influence an operational parameter Bia of the mixing apparatus 18a. As a consequence of this influence, the first stream 12a of medium and/or the position of the mixing apparatus 18a is set or adjusted such that, following the emergence of the first stream 12a of medium from the opening 22a of the mixing apparatus 18a, the steering of the first stream 12a of medium by the Coanda surface 24a of the mixing apparatus 12a and the mixing of the first stream 12a of medium with the second stream 16a of medium, at VI, the parameter Tista or the temperature evoking a feeling of wellbeing is set in the cabin 50a.

The desired parameter Tsolla can be selected separately for each cabin 50a and is individually set by the apparatuses 10a, 10a′ or the respective mixing apparatus 18a for each cabin 50a.

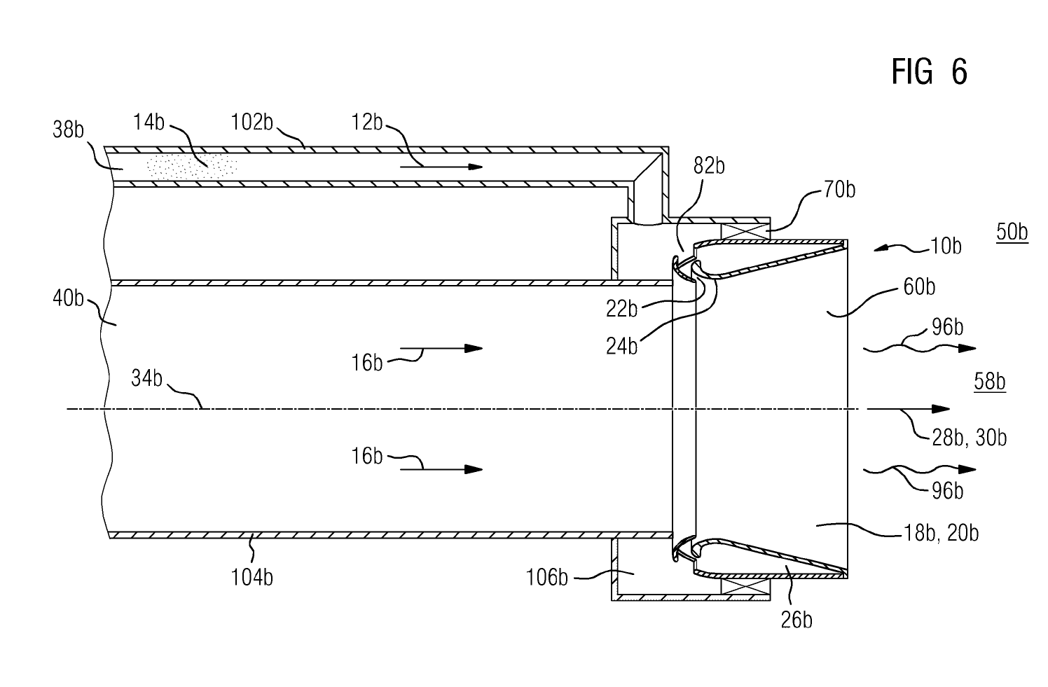

FIG. 6 shows an alternative example embodiment of the apparatus 10a. In principle, the same components, features and functions are essentially identified with the same reference signs. However, in order to distinguish the exemplary embodiments, the letters a and b are added to the reference signs of the exemplary embodiments. The following description is essentially restricted to the differences from the exemplary embodiment in FIGS. 1 to 5 and, with regard to components, features and functions which remain the same, reference can be made to the description of the exemplary embodiment in FIGS. 1 to 5.

The example embodiment of FIG. 6 differs from that of FIGS. 1 to 5 in that an apparatus 10b has a first infeed 38b for a first stream 12b of a flow medium 14b and a second infeed 40a for a second stream 16b, said infeeds being provided as two tubes 102b, 104b constructed separately from one another. The tubes 102b, 104b extend parallel to an axis 34b. The first tube 102b of the first infeed 38b opens into a sleeve 106b which is closed in the direction of the second tube 104b and is penetrated by the second tube 104b. Furthermore, a mixing apparatus 18b is provided in the sleeve 106b at a side opposing the second tube 104b, and is axially displaceable via a seal 70b. The first infeed 38b guides the first stream 12b of medium through a cut-out 82b to a distribution channel 26a of the mixing apparatus 18b. Said mixing apparatus is configured as a blade-free fan 20b with an opening 22b and a Coanda surface 24b arranged in the region of the opening 22b. Following emergence from the opening 22b and steering by the Coanda surface 24b, the first stream 12b of medium mixes with the second stream 16b, which, following a supply line, flows through the second infeed 40b in the region of the opening 22b. A combined stream 96b of the first and second streams 12b, 16b of medium is blown out in the flow direction 30b or in an opening direction 28b of the opening 22b into an interior space 58b of a cabin 50b.

1. An apparatus for mixing a first stream of a flow medium and a second stream of the flow medium, a temperature of the first stream being different from a temperature of the second stream, comprising:
at least one mixing apparatus, configured as a blade-free fan, including at least one opening and a Coanda surface arranged in a region of the at least one opening, the at least one mixing apparatus being configured such that the first stream is to emerges from the at least one opening and is steerable by the Coanda surface, and such that the second stream is to flow in the region of the at least one opening, wherein the first stream, following an emergence thereof from the at least one opening, is mixable with the second stream, the at least one mixing apparatus including
a first infeed, configured to feed the first stream to the mixing apparatus; and
a second infeed, configured to feed the second stream to the mixing apparatus, the first infeed and the second infeed being configured as a double-walled tube.

2. The apparatus of claim 1, wherein, during an operation of the at least one mixing apparatus, the temperature of the second stream flowing in the region of the at least one opening is relatively higher than the temperature of the first stream emerging from the at least one opening.

3. The apparatus of claim 1, wherein, during an operation of the at least one mixing apparatus, a speed of the second stream flowing in the region of the at least one opening is relatively lower than a speed of the first stream emerging from the at least one opening.

4. The apparatus of claim 1, wherein, during an operation of the at least one mixing apparatus, a pressure of the second stream flowing in the region of the at least one opening is relatively lower than a pressure of the first stream emerging from the at least one opening.

5. The apparatus of claim 1, wherein the blade-free fan includes at least one distribution channel for at least the first stream, and wherein the distribution channel is configured to supply the at least one opening with flow medium.

6. The apparatus of claim 1, wherein at least one of
the at least one opening includes an opening direction oriented substantially parallel to a flow direction of the first stream, and
the at least one opening is configured to provide the blade-free fan with an effect of a nozzle.

7. The apparatus of claim 1, wherein the Coanda surface is arranged in the flow direction of the first stream after the at least one opening.

8. The apparatus of claim 1, wherein, at least one of
that the Coanda surface extends symmetrically to an axis, and
the Coanda surface and the axis enclose an angle in the range of 7° to 20°.

9. The apparatus of claim 1, wherein the blade-free fan is configured annular.

10. The apparatus of claim 1, further comprising:
a fluid flow machine, at least one of configured to generates the first stream and adjustable by way of at least one state parameter of the first stream.

11. The apparatus of claim 1, wherein the blade-free fan is arranged axially displaceable relative to one of the infeeds configured to feed in at least one of the first stream and the second stream to the at least one mixing apparatus.

12. A method for mixing a first stream of a flow medium and a second stream of the flow medium, a temperature of the first stream being different from a temperature of the second stream, the method comprising: conducting
the first stream and the second stream through a double-walled tube to a mixing apparatus;
blowing the first stream out of at least one opening of the mixing apparatus;
steering the first steam with a Coanda surface, arranged in the region of the at least one opening; and mixing the first stream, following emergence from the at least one opening, with the second stream.

13 An air-conditioning system comprising at least two apparatuses of claim 1.

14. A method for operating an air-conditioning system as claimed in claim 13, the method comprising:
selecting a parameter at an adjusting unit;
influencing, depending on the selected parameter, at least one of a state parameter of the first stream and an operational parameter of the mixing apparatus, such that, following emergence of the first stream from the at least one opening of the mixing apparatus, steering of the first stream via of the mixing apparatus, and mixing of the first stream with the second stream, the parameter has been adjusted.

15. (canceled)

16. The apparatus of claim 2, wherein, during an operation of the at least one mixing apparatus, a speed of the second stream flowing in the region of the at least one opening is relatively lower than a speed of the first stream emerging from the at least one opening.

17. The apparatus of claim 2, wherein, during an operation of the at least one mixing apparatus, a pressure of the second stream flowing in the region of the at least one opening is relatively lower than a pressure of the first stream emerging from the at least one opening.

18. The apparatus of claim 3, wherein, during an operation of the at least one mixing apparatus, a pressure of the second stream flowing in the region of the at least one opening is relatively lower than a pressure of the first stream emerging from the at least one opening.

19. The apparatus of claim 16, wherein, during an operation of the at least one mixing apparatus, a pressure of the second stream flowing in the region of the at least one opening is relatively lower than a pressure of the first stream emerging from the at least one opening.

20. The apparatus of claim 2, wherein the blade-free fan includes at least one distribution channel for at least the first stream, and wherein the distribution channel is configured to supply the at least one opening with flow medium.

21. The apparatus of claim 2, wherein at least one of
the at least one opening includes an opening direction oriented substantially parallel to a flow direction of the first stream, and
the at least one opening is configured to provide the blade-free fan with an effect of a nozzle.

22. The apparatus of claim 2, wherein the Coanda surface is arranged in the flow direction of the first stream after the at least one opening.

23. The method of claim 12, wherein, during an operation of the at least one mixing apparatus, the temperature of the second stream flowing in the region of the at least one opening is relatively higher than the temperature of the first stream emerging from the at least one opening.

24. The method of claim 12, wherein, during an operation of the at least one mixing apparatus, a speed of the second stream flowing in the region of the at least one opening is relatively lower than a speed of the first stream emerging from the at least one opening.

25. The method of claim 12, wherein, during an operation of the at least one mixing apparatus, a pressure of the second stream flowing in the region of the at least one opening is relatively lower than a pressure of the first stream emerging from the at least one opening.

26. The method of claim 23, wherein, during an operation of the at least one mixing apparatus, a speed of the second stream flowing in the region of the at least one opening is relatively lower than a speed of the first stream emerging from the at least one opening.

27. The method of claim 26, wherein, during an operation of the at least one mixing apparatus, a pressure of the second stream flowing in the region of the at least one opening is relatively lower than a pressure of the first stream emerging from the at least one opening.
